(19) United States
(12) Patent Application Publication
(10) Pub. No.: US 2005/0241540 A1
(43) Pub. Date: Nov. 3, 2005

(54) Cement-based plasters using water retention agents prepared from raw cotton linters

(76) Inventors: Wilfried Hohn, Erftstadt (DE); Dieter Schweizer, Dusseldorf (DE)

Correspondence Address: Hercules Incorporated;Hercules Plaza, 1313 N. Market Street, Wilmington, DE, 19894-0001, US

(21) Appl. No.: 11/113,262

(22) Filed: Apr. 22, 2005

Related U.S. Application Data
(60) Provisional application No. 60/565,643, filed on Apr. 27, 2004.

(51) Int. Cl. C04B 7/00

(52) U.S. Cl. 106/805

(57) ABSTRACT

A mixture composition of a cellulose ether made from raw cotton linters and at least one additive is used in a dry cement based plaster (or render) composition wherein the amount of the cellulose ether in the render composition is significantly reduced. When this render composition is mixed with water and applied to a substrate, the water retention and thickening and/or sag resistance of the wet plaster are comparable or improved as compared to when using conventional similar cellulose ethers.

This application claims the benefit of U.S. Provisional Application No. 60/565,643, filed Apr. 27, 2004

### FIELD OF THE INVENTION

This invention relates to a mixture composition useful in dry cement based plaster (or render) compositions for plastering walls. More specifically, this invention relates to dry cement-based plasters (or renders) using an improved water retention agent that is prepared from raw cotton linters.

### BACKGROUND OF THE INVENTION

Traditional cement-based plasters are often simple mixtures of cement and sand. The dry mixture is mixed with water to form a mortar. These traditional mortars, per se, have poor fluidity or trowelability. Consequently, the application of these mortars is labor intensive, especially in summer months under hot weather conditions, because of the rapid evaporation or removal of water from the mortar, which results in inferior or poor workability as well as insufficient hydration of cement.

The physical characteristics of a hardened traditional mortar are strongly influenced by its hydration process, and thus, by the rate of water removal therefrom during the setting operation. Any influence, which affects these parameters by increasing the rate of water removal or by diminishing the water concentration in the mortar at the onset of the setting reaction, can cause a deterioration of the physical properties of the mortar. Many substrates, such as lime sandstone, cinderblock, wood or masonry are porous and able to remove a significant amount of water from the mortar leading to the difficulties just mentioned.

To overcome, or to minimize, the above mentioned water-loss problems, the prior art discloses uses of cellulose ethers as water retention agents to mitigate this problem. An example of this prior art is U.S. Pat. No. 4,501,617 that discloses the use of hydroxypropylhydroxyethylcellulose (HPHEC) as a water retention aid for improving trowellability or fluidity of mortar. The uses of cellulose ether in dry-mortar applications are also disclosed in DE 3046585, EP 54175, DE 3909070, DE3913518, CA2456793, EP 773198.

German publication 4,034,709 A1 discloses the use of raw cotton linters to prepare cellulose ethers as additives to cement based hydraulic mortars or concrete compositions.

Cellulose ethers (CEs) represent an important class of commercially important water-soluble polymers. These CEs are capable of increasing viscosity of aqueous media. This viscosifying ability of a CE is primarily controlled by its molecular weight, chemical substituents attached to it, and conformational characteristics of the polymer chain. CEs are used in many applications, such as construction, paints, food, personal care, pharmaceuticals, adhesives, detergents/cleaning products, oilfield, paper industry, ceramics, polymerization processes, leather industry, and textiles.

Methylcellulose (MC), methyl hydroxyethylcellulose (MHEC), ethylhydroxyethylcellulose (EHEC), methylhydroxypropylcellulose (MH PC), and hydroxyethylcellulose (HEC), hydrophobically modified hydroxyethylcellulose (HMHEC) either alone or in combination are widely used for dry mortar formulations in the construction industry. By a dry mortar formulation is meant a blend of gypsum, cement, and/or lime as the inorganic binder used either alone or in combination with aggregates (e.g., silica and/or carbonate sand/powder), and additives.

For their use, these dry mortars are mixed with water and applied as wet materials. For the intended applications, water-soluble polymers that give high viscosity upon dissolution in water are required. By using MC, MHEC, MHPC, EHEC, HEC, and HMHEC or combinations thereof, desired plaster properties such as high water retention (and consequently a defined control of water content) are achieved. Additionally, an improved workability and satisfactory adhesion of the resulting material can be observed. Since an increase in CE solution viscosity results in improved water retention capability and adhesion, high molecular weight CEs are desirable in order to work more efficiently and cost effectively. In order to achieve high solution viscosity, the starting cellulose ether has to be selected carefully. Currently, by using purified cotton linters or high viscosity wood pulps, the highest 2 wt % aqueous solution viscosity that can be achieved for alkylhydroxyalkylcelluloses is about 70,000-80,000 mPas (as measured using Brookfield RVT viscometer at 20° C. and 20 rpm, using a spindle number 7).

A need still exists in the cement plaster industry for having a water retention agent that can be used in a cost-effective manner to improve the application and performance properties of cement based plasters. In order to assist in achieving this result, it would be preferred to provide a water retention agent that provides an aqueous Brookfield solution viscosity of preferably greater than about 80,000 mPas and still be cost effective for use as a thickener and/or water retention agent.

### SUMMARY OF THE INVENTION

The present invention relates to a mixture composition for use in a render composition of a cellulose ether in an amount of 20 to 99.9 wt % of alkylhydroxyalkylcelluloses and hydroxyalkylcelluloses and mixtures thereof, prepared from raw cotton linters, and at least one additive in an amount of 0.1 to 80 wt % selected from the group consisting of organic or inorganic thickening agents, anti-sag agents, air entraining agents, wetting agents, defoamers, superplasticizers, dispersants, calcium-complexing agents, retarders, accelerators, water repellants, redispersible powders, biopolymers, and fibres; the mixture composition, when used in a dry cement based plaster (or render) composition and mixed with a sufficient amount of water, the cement based plaster (or render) composition produces a plaster mortar which can be applied on substrates wherein the amount of the mixture in the plaster mortar is significantly reduced while water retention and thickening and/or sag-resistance of the wet mortar are comparable or improved as compared to when using conventional similar cellulose ethers.

The present invention also is directed to dry-mortar cement-based plaster (or render) composition of hydraulic cement, fine aggregate material, and a water-retaining agent of at least one cellulose ether prepared from raw cotton linters. The cement-based plaster (or render) composition, when mixed with a sufficient amount of water, produces a plaster mortar which can be applied on substrates, such as walls, wherein water retention and thickening and/or sag-resistance of the wet mortar are comparable or improved as compared to when using conventional similar cellulose ethers.

### BRIEF DESCRIPTION OF THE DRAWINGS

FIG. 1 is a graphical representation of the experimental data set forth in Example 3, infra;

FIG. 2 is a graphical representation of the experimental data set forth in Example 4, infra;

FIG. 3 is a graphical representation of the experimental data set forth in Example 7, infra;

FIG. 4 is a graphical representation of the experimental data set forth in Example 8, infra;

### DETAILED DESCRIPTION OF THE INVENTION

It has been found that certain cellulose ethers, particularly alkylhydroxyalkylcelluloses and hydroxyalkylcelluloses, made from raw cotton linters (RCL) have unusually high solution viscosity relative to the viscosity of conventional, commercial cellulose ethers made from purified cotton linters or high viscosity wood pulps. The use of these cellulose ethers in cement based plaster (or render) compositions provides several advantages (i.e., lower cost in use and better application properties) and improved performance properties that were hitherto not possible to achieve using conventional cellulose ethers.

In accordance with this invention, cellulose ethers of the present invention such as alkylhydroxyalkylcelluloses and hydroxyalkylcelluloses are prepared from cut or uncut raw cotton linters. The alkyl group of the alkylhydroxyalkylcelluloses has 1 to 24 carbon atoms and the hydroxyalkyl group has 2 to 4 carbon atoms. Also, the hydroxyalkyl group of the hydroxyalkylcelluloses has 2 to 4 carbon atoms. These cellulose ethers provided unexpected and surprising benefits to the cement-based plaster (or render). Because of the extremely high viscosity of the RCL-based CEs, efficient application performance in cement based plasters (or renders) could be observed. Even at lower use level of the RCL based CEs as compared to currently used high viscosity commercial CEs, similar or improved application performance with respect to water retention is achieved

It could also be demonstrated that alkylhydroxyalkylcelluloses and hydroxyalkylcelluloses, such as methylhydroxyethylcelluloses, methylhydroxypropylcelluloses hydroxyethylcelluloses, and hydrophobically modified hydroxyethylcelluloses, prepared from RCL give significant body and improved sag-resistance to plaster mortars.

In accordance with the present invention, the mixture composition has an amount of the RCL based cellulose ether of 20 to 99.9 wt %, preferably 70 to 99.0 wt % based on the total weight of the mixture.

The RCL based, water-soluble, nonionic CEs of the present invention include (as primary CEs) particularly, alkylhydroxyalkylcelluloses and hydroxyalkylcelluloses made from (RCL). Examples of such derivatives include methylhydroxyethylcelluloses (M HEC), methylhydroxypropylcelluloses (MH PC), methylethylhydroxyethylcelluloses (MEHEC), ethylhydroxyethylcelluloses (EHEC), hydrophobically modified ethylhydroxyethylcelluloses (HMEHEC), hydroxyethylcellulose (HEC) and hydrophobically modified hydroxyethylcelluloses (HMHEC), and mixtures thereof. The hydrophobic substituent can have 1 to 25 carbon atoms. Depending on their chemical composition, they can have, where applicable, a methyl or ethyl degree of substitution (DS) of 0.5 to 2.5, a hydroxyalkyl molar substitution (HA-MS) of about 0.01 to 6, and a hydrophobic substituent molar substitution (HS-MS) of about 0.01 to 0.5 per anhydroglucose unit. More particularly, the present invention relates to the use of these water-soluble, nonionic CEs as efficient thickener and water retention agents in dry-mortar cement-based plasters, e.g., base coat render, one coat render, light weight render, decorative render, skim coat and/or finishing plaster, and external finishing insulation systems (EFIS).

In practicing the present invention, conventional CEs (secondary CEs) made from purified cotton linters and wood pulps can be used in combination with RCL based CEs. The preparation of various types of CEs from purified celluloses is known in the art. These secondary CEs can be used in combination with the primary RCL based CEs for practicing the present invention. These secondary CEs will be referred to in this application as conventional CEs because most of them are commercial products or known in the marketplace and/or literature.

Examples of the secondary CEs are methylcellulose (MC), methylhydroxyethylcellulose (MHEC), methylhydroxypropylcellulose (MHPC), hydroxyethylcellulose (HEC), ethylhydroxyethylcellulose (EHEC), methylethylhydroxyethylcellulose (MEHEC), hydrophobically modified ethylhydroxyethylcelluloses (HMEHEC), hydrophobically modified hydroxyethylcelluloses (HMHEC), sulfoethyl methylhydroxyethylcelluloses (SEMHEC), sulfoethyl methylhydroxypropylcelluloses (SEMHPC), and sulfoethyl hydroxyethylcelluloses (SEHEC).

In accordance with the present invention, one preferred embodiment makes use of MHEC or MHPC having 2% aqueous solution Brookfield viscosity of greater than 80,000 mPas, preferably greater than 90,000 mPas, as measured on a Brookfield RVT viscometer at 20° C. and 20 rpm using spindle number 7.

In accordance with the present invention, the mixture composition has an amount of at least one additive of between 0.1 and 80 wt %, preferably between 0.5 and 30 wt %. Examples of the additives are organic or inorganic thickening agents and/or secondary water retention agents, anti-sag agents, air entraining agents, wetting agents, defoamers, superplasticizers, dispersants, retarders, accelerators, water repellants, redispersible powders, biopolymers, and fibres. An example of the organic thickening agent is polysaccharides. Other examples of additives are calcium chelating agents, fruit acids, and surface-active agents.

More specific examples of the additives are homo- or co-polymers of acrylamide. Examples of such polymers are of poly(acrylamide-co-sodium acrylate), poly(acrylamide-co-acrylic acid), poly(acrylamide-co-sodium-acrylamido methylpropanesulfonate), poly(acrylamide-co-acrylamido methylpropanesulfonic acid), poly(acrylamide-co-diallyidimethylammonium chloride), poly(acrylamide-co-(acryloylamino)propyltrimethylammoniumchloride), poly(acrylamide-co-(acryloyl)ethyltrimethylammoniumchloride), and mixtures thereof.

Examples of the polysaccharide additives are starch ether, starch, guar, guar derivatives, dextran, chitin, chitosan, xylan, xanthan gum, welan gum, gellan gum, mannan, galactan, glucan, arabinoxylan, and, alginate.

Other specific examples of the additives are gelatin, polyethylene glycol, casein, lignin sulfonates, naphthalene-sulfonate, sulfonated melamine-formaldehyde condensate, sulfonated naphthalene-formaldehyde condensate, polyacrylates, polycarboxylate ether, polystyrene sulphonates, fruit acids, phosphates, phosphonates, calcium-salts of organic acids having 1 to 4 carbon atoms, salts of alkanoates, aluminum sulfate, metallic aluminum, bentonite, montmorillonite, sepiolite, polyamide fibres, polypropylene fibres, polyvinyl alcohol, and homo-, co-, or terpolymers based on vinyl acetate, maleic ester, ethylene, styrene, butadiene, vinyl versatate, and acrylic monomers.

The mixture compositions of this invention can be prepared by a wide variety of techniques known in the prior art. Examples include simple dry blending, spraying of solutions or melts onto dry materials, co-extrusion, or co-grinding.

In accordance with the present invention, the mixture composition when used in a dry cement based plaster (or render) formulation and mixed with a sufficient amount of water to produce a plaster mortar, the amount of the mixture, and consequently the cellulose ether, is significantly reduced. The reduction of the mixture or cellulose ether is at least 5%, preferably at least 10%. Even with such reductions in the CE, the water retention and thickening and/or sag-resistance of the wet plaster mortar are comparable or improved as compared to when using conventional similar cellulose ethers.

The mixture composition of the present invention can be marketed directly or indirectly to cement based plaster manufacturers who can use such mixtures directly into their manufacturing facilities. The mixture composition can also be custom blended to preferred requirements of different manufacturers.

The cement based plaster (or render) composition of the present invention has an amount of RCL based CE of from about 0.01 to 1.0 wt %. The amount of the at least one additive is from about 0.0001 to 10 wt %. These weight percentages are based on the total dry weight of all of the ingredients of the dry cement based plaster (or render).

In accordance with the present invention, the dry cement based plaster (or render) composition has fine aggregate material present, in the amount of 40-90 wt %, preferably in the amount of 60-85 wt %. Examples of the fine aggregate materials are silica sand, dolomite, limestone, lightweight aggregates (e.g. perlite, expanded polystyrene, hollow glass spheres, cork, expanded vermiculite), rubber crumbs (recycled from car tires), and fly ash. By “fine” is meant that the aggregate materials have particle sizes up to 2.0 mm, preferably 1.0 mm.

In accordance with the present invention, the hydraulic cement component is present in the amount of 5-60 wt %, and preferably in the amount of 10-50 wt %. Examples of the hydraulic cement are Portland cement, Portland-slag cement, Portland-silica fume cement, Portland-pozzolana cement, Portland-burnt shale cement, Portland-limestone cement, Portland-composite cement, blast furnace cement, pozzolana cement, composite cement and calcium aluminate cement.

In accordance with the present invention, the dry cement plaster (or render) composition has an amount of at least one mineral binder of between 5 and 60 wt %, preferably between 10 and 50 wt %. Examples of the at least one inorganic binder are cement, pozzolana, blast furnace slag, hydrated lime, gypsum, and hydraulic lime.

In accordance with a preferred embodiment of the invention, cellulose ethers are prepared according to U.S. patent application Ser. No. 10/822,926, filed Apr. 13, 2004, which is herein incorporated by reference. The starting material of this embodiment of the present invention is a mass of unpurified raw cotton linter fibers that has a bulk density of at least 8 grams per 100 ml. At least 50 wt % of the fibers in this mass have an average length that passes through a US sieve screen size number 10 (2 mm openings). This mass of unpurified raw cotton linters is prepared by obtaining a loose mass of first cut, second cut, third cut and/or mill run unpurified, natural, raw cotton linters or mixtures thereof containing at least 60% cellulose as measured by AOCS (American Oil Chemists' Society) Official Method Bb 3-47 and commuting the loose mass to a length wherein at least 50 wt % of the fibers pass through a US standard sieve size number 10. The cellulose ether derivatives are prepared using the above-mentioned comminuted mass of raw cotton linter fibers as the starting material. The cut mass of raw cotton linters is first treated with a base in a slurry or high solids process at a cellulose concentration of greater than 9 wt % to form an activated cellulose slurry. Then, the activated cellulose slurry is reacted for a sufficient time and at a sufficient temperature with an etherifying agent or a mixture of etherifying agents to form the cellulose ether derivative, which is then recovered. The modification of the above process to prepare the various CEs of the present invention is well known in the art.

The CEs of this invention can also be prepared from uncut raw cotton linters that are obtained in bales of the RCL that are either first, second, third cut, and/or mill run obtained from the manufacturer.

Raw cotton linters including compositions obtained by mechanical cleaning of “as is” raw cotton linters, which are substantially free of non-cellulosic foreign matters, such as field trash, debris, seed hulls, etc., can also be used to prepare cellulose ethers of the present invention. Mechanical cleaning techniques of raw cotton linters, including those involving beating, screening, and air separation techniques, are well known to those skilled in the art. Using a combination of mechanical beating techniques and air separation techniques fibers are separated from debris by taking advantages of the density difference between fibers and debris. A mixture of mechanically cleaned raw cotton linters and “as is” raw cotton linters can also be used to manufacture cellulose ethers of the present invention.

When compared with the cement based plaster (or render) prepared with conventional cellulose ethers, the plaster mortars of this invention provide improved water retention, thickening, and sag-resistance, which are important parameters used widely in the art to characterize cement-based plasters.

According to European Norm EN 1015-8 water retention and/or water retentivity is “the ability of a fresh hydraulic mortar to retain its mixing water when exposed to substrate suction”. It can be measured according to the European Norm EN 18555.

Sag-resistance is the ability of a vertically applied fresh mortar to keep its position on the wall, i.e., good sag-resistance prevents the fresh wet mortar from flowing down. For cement-based plasters it is often subjectively rated by the responsible craftsman. It is correlated to the thickening of the investigated cement-based plaster. Thickening and/or flow can be measured according to DIN EN 18555 using a flow table.

A typical dry cement plaster/render might contain some or all of the following components:

TABLE A
Typical Prior Art Composition of dry cement plaster (or render)

| | Typical amount | |
|---|---|---|
| Component | [wt %] | Examples |
| Cement | 5-60% | CEM I (Portland cement), CEM |
| | | II, CEM III (blast-furnace |
| | | cement), CEM IV (pozzolana |
| | | cement), CEM V (composite |
| | | cement), CAC (calcium aluminate |
| | | cement) |
| Other mineral | 0.5-30% | Hydrated lime, gypsum, lime, |
| binders | | pozzolana, blast furnace |
| | | slag, and hydraulic lime |
| Aggregate/ | 5-90% | Silica sand, dolomite, |
| light weight | | limestone, perlite, EPS (expanded |
| aggregate | | polystyrene), hollow glass |
| | | spheres, expanded vermiculite |
| Spray dried | 0-4% | Homo-, co-, or terpolymers |
| resin | | based on vinyl acetate, |
| | | maleic ester, ethylene, |
| | | styrene, butadiene, vinyl |
| | | versatate, and/or acrylic |
| | | monomers |
| Accelerator/ | 0-2% | Calcium formate, sodium |
| retarder | | carbonate, lithium carbonate, |
| | | tartaric acid, citric acid, |
| | | or other fruit acids |
| Cellulose ether | 0.01-1% | Methylcellulose (MC), |
| | | methylhydroxyethylcellulose |
| | | (MHEC), methylhydroxypropyl- |
| | | cellulose (MHPC), |
| | | ethylhydroxyethylcellulose |
| | | (EHEC), hydroxyethylcellulose |
| | | (HEC), hydrophobically modified |
| | | hydroxyethylcellulose (HMHEC) |
| Other | 0-1% | Air entraining agents, |
| additives | | defoamers, hydrophobic agents, |
| | | wetting agents, super- |
| | | plasticizers, anti-sag agents, |
| | | calcium-complexing agents |
| Fibre | 0-5% | Cellulose fibre, polyamide |
| | | fibre, polypropylene fibre |

The invention is further illustrated by the following Examples. Parts and percentages are by weight, unless otherwise noted.

### EXAMPLE 1

Examples 1 and 2 show some of the chemical and physical properties of the polymers of the instant invention as compared to similar commercial polymers.

Determination of Substitution

Cellulose ethers were subjected to a modified Zeisel ether cleavage at 150° C. with hydriodic acid. The resulting volatile reaction products were determined quantitatively with a gas chromatograph.

Determination of Viscosity

The viscosities of aqueous cellulose ether solutions were determined on solutions having concentrations of 1 wt % and 2 wt %. When ascertaining the viscosity of the cellulose ether solution, the corresponding methylhydroxyalkylcellulose was used on a dry basis, i.e., the percentage moisture was compensated by a higher weight-in quantity. Viscosities of currently available, commercial methylhydroxyalkylcelluloses, which are based on purified cotton linters or high viscosity wood pulps have maximum 2 wt % aqueous solution viscosity of about 70,000 to 80,000 mPas (measured using Brookfield RVT viscometer at 20° C. and 20 rpm, using a spindle number 7).

In order to determine the viscosities, a Brookfield RVT rotational viscometer was used. All measurements at 2 wt % aqueous solutions were made at 20° C. and 20 rpm, using a spindle number 7.

Sodium Chloride Content

The sodium chloride content was determined by the Mohr method. 0.5 g of the product was weighed on an analytical balance and was dissolved in 150 ml of distilled water. 1 ml of 15% HNO₃ was then added after 30 minutes of stirring. Afterwards, the solution was titrated with normalized silver nitrate (AgNO₃) solution using a commercially available apparatus.

Determination of Moisture

The moisture content of the sample was measured using a commercially available moisture balance at 105° C. The moisture content was the quotient from the weight loss and the starting weight, and is expressed in percent.

Determination of Surface Tension

The surface tensions of the aqueous cellulose ether solutions were measured at 20° C. and a concentration of 0.1 wt % using a Krüss Digital-Tensiometer K10. For determination of surface tension the so-called “Wilhelmy Plate Method” was used, where a thin plate is lowered to the surface of the liquid and the downward force directed to the plate is measured.

TABLE 1
Analytical Data

| | Methoxyl/ | | | | |
|---|---|---|---|---|---|
| | Hydroxyethoxyl | Viscosity | | | |
| | or | on dry basis | | | Surface |
| | Hydroxypropoxyl | at 2 wt % | at 1 wt % | Moisture | tension* |
| Sample | [%] | [mPas] | [mPas] | [%] | [mN/m] |
| RCL-MHPC | 26.6/2.9 | 95400 | 17450 | 2.33 | 35 |
| MHPC 65000 | 27.1/3.9 | 59800 | 7300 | 4.68 | 48 |
| (control) | | | | | |
| RCL-MHEC | 23.3/8.4 | 97000 | 21300 | 2.01 | 43 |
| MHEC 75000 | 22.6/8.2 | 67600 | 9050 | 2.49 | 53 |
| (control) | | | | | |

*0.1 wt % aqueous solution at 20° C.

Table 1 shows the analytical data of a methylhydroxyethylcellulose and a methylhydroxypropylcellulose derived from RCL. The results clearly indicate that these products have significantly higher viscosities than current, commercially available high viscosity types. At a concentration of 2 wt %, viscosities of about 100,000 mPas were found. Because of their extremely high values, it was more reliable and easier to measure viscosities of 1 wt % aqueous solutions. At this concentration, commercially available high viscosity methylhydroxyethylcelluloses and methylhydroxypropylcelluloses showed viscosities in the range of 7300 to about 9000 mPas (see Table 1). The measured values for the products based on raw cotton linters were significantly higher than the commercial materials. Moreover, the data in Table 1 clearly indicate that the cellulose ethers which are based on raw cotton linters have lower surface tensions than the control samples.

### EXAMPLE 2

Determination of Substitution

Cellulose ethers were subjected to a modified Zeisel ether cleavage at 150° C. with hydriodic acid. The resulting volatile reaction products were determined quantitatively with a gas chromatograph.

Determination of Viscosity

The viscosities of aqueous cellulose ether solutions were determined on solutions having concentrations of 1 wt %. When ascertaining the viscosity of the cellulose ether solution, the corresponding hydroxyethylcellulose was used on a dry basis, i.e., the percentage of moisture was compensated by a higher weight-in quantity.

In order to determine the viscosities, a Brookfield LVF rotational viscometer was used. All measurements were made at 25° C. and 30 rpm, using a spindle number 4.

Hydroxyethylcellulose made from purified as well as raw cotton linters were produced in Hercules' pilot plant reactor. As indicated in Table 2 both samples have about the same hydroxyethoxyl-content. But viscosity of the resulting HEC based on RCL is about 23% higher.

TABLE 2
Analytical Data of HEC-samples

| | Hydroxyethoxyl | at 1 wt % |
|---|---|---|
| | [%] | [mPas] |
| Purified linters HEC | 58.7 | 3670 |
| RCL-HEC | 57.1 | 4530 |

### EXAMPLE 3

All tests were conducted in a render base-coat basic-mixture of 14.0 wt % Portland Cement CEM I 42.5R, 4.0 wt % hydrated lime, 39.0 wt % silica sand with particle sizes of 0.1-0.4 mm and 43.0 wt % silica sand with particle sizes of 0.5-1.0 mm.

Water Retention

Water retention was either determined according to DIN EN 18555 or the internal Hercules/Aqualon working procedure.

Hercules/Aqualon Working Procedure

Within 5 seconds 300 g of dry mortar were added to the corresponding amount of water (at 20° C.). After mixing the sample for 25 seconds using a kitchen handmixer, the resulting sample was allowed to mature for 5 minutes. Then, the mortar was filled into a plastic ring, which was positioned on a piece of filter paper. Between the filter paper and the plastic ring, a thin fibre fleece was placed while the filter paper was lying on a plastic plate. The weight of the arrangement was measured before and after the mortar was filled in. Thus, the weight of the wet mortar was calculated. Moreover, the weight of the filter paper was known. After soaking the filter paper for 3 min, the weight of the filter paper was measured again. Now, the water retention [%] was calculated using the following formula:

$$W R [ \% ] = 100 - \frac{100 \times W U \times ( 1 + W F )}{W P \times W F}$$

with
   WU=water uptake of filter paper [g]
   WF=water factor*
WP=weight of plaster [g]
   * water factor: amount of used water divided by amount of used dry mortar, e.g. 20 g of water on 100 g of dry mortar results in a water factor of 0.2
   Flow, Density and Air-Content of Mortar

Flow, density and air-content of the resulting mortar were determined according to DIN EN 18555 procedure.

Methylhydroxyethylcellulose (MHEC) made from RCL was tested in a base coat render (cement-based plaster) basic-mixture in comparison to commercially available, high viscosity MHEC (from Hercules) as the control. The results are shown in Table 3.

TABLE 3
Testing of different cellulose ethers in base coat
render (23° C./50% relative air humidity)

| Basic material | Basic mixture base coat render | | |
|---|---|---|---|
| Additives (amount on | 0.1% MHEC 75000 + | 0.08% MHEC 75000 + | 0.08% RCL-MHEC + |
| basic-mixture) | 0.01% AEA | 0.01% AEA | 0.01% AEA |
| | (air entraining agent; | | |
| | sodium C12-C18 | | |
| | alkyl sulfate) | | |
| Water factor | 0.2 | 0.2 | 0.2 |
| Water retention | 98.15 | 96.22 | 98.10 |
| (%, DIN) | | | |
| Flow (mm) | 183 | 182 | 177 |
| Fresh mortar | 1734 | 1766 | 1730 |
| density (g/l) | | | |
| Air content (%) | 18.5-19 | 17-17.5 | 18.5-19 |

First, the control (MHEC 75000) was tested at the typical addition level of 0.1% (on basic-mixture). When use level was reduced to 0.08%, a significant drop in water retention was measured for the resulting base coat render. Moreover, air content decreased slightly which could also be seen in the slightly higher fresh mortar density of the resulting render. In another test, RCL-based MHEC was tested at an addition level of 0.08%. Although the dosage level was reduced by 20% in comparison to the control sample, water retention, air content and fresh mortar density were still the same. Moreover, a stronger thickening effect could be observed, which was indicated by the lower flow value.

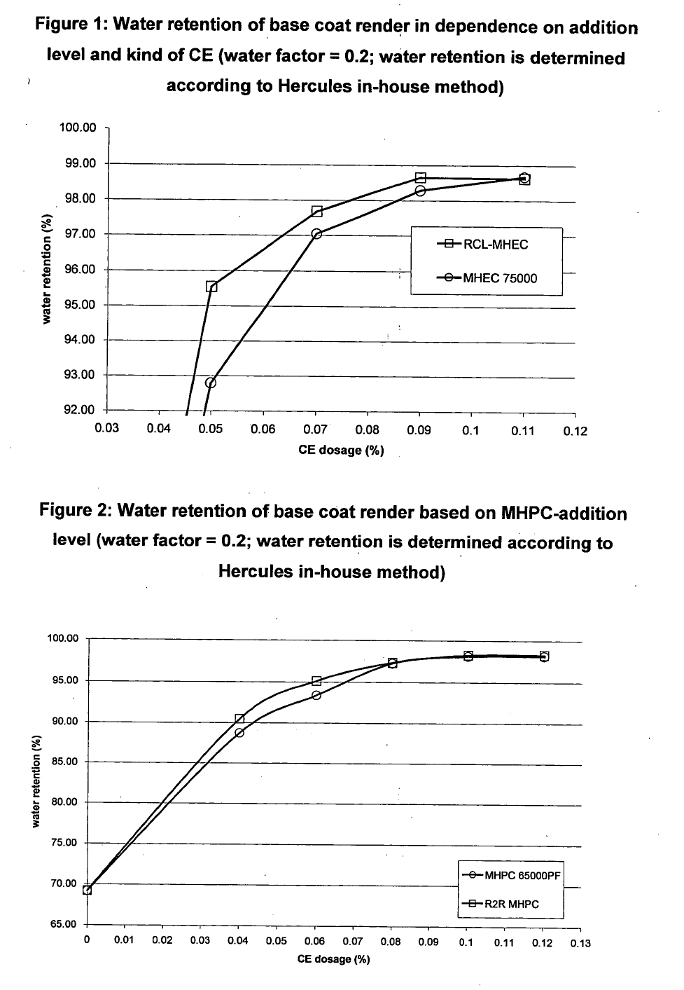

In another test series water retention of base coat render was determined based on CE-addition level. Again, RCL-based MHEC was compared with the control (MHEC 75000). The outcome of this investigation can be seen in FIG. 1.

It is clearly demonstrated that RCL-based MHEC has a superior application performance with respect to water retention capability as compared to currently used very high viscosity MHEC. Especially, at a lower CE-dosage, a clear advantage of the RCL-based material is seen. Here, at the same addition level higher water retention was achieved, i.e., the same water retention was reached at a significantly reduced dosage.

Thus, Table 3 and FIG. 1 clearly show that RCL-based MHEC exhibits similar application performance at reduced addition level.

### EXAMPLE 4

All tests were conducted in a render base-coat basic-mixture of 14.0 wt % Portland Cement CEM I 42.5R, 4.0 wt % hydrated lime, 39.0 wt % silica sand with particle sizes of 0.1-0.4 mm and 43.0 wt % silica sand with particle sizes of 0.5-1.0 mm.

Determination of Water Retention, Flow, Density and Air-Content of Mortar

Water retention, flow, density and air-content of the wet mortar were determined as described in Example 3.

Methylhydroxypropylcellulose (MHPC) made from RCL was tested in a base coat render (cement-based plaster) basic-mixture in comparison to commercially available, high viscosity MHPC (from Hercules) as the control. In order to have a better workability, in all cases an air-entraining agent (AEA) (sodium C12-C18 alkyl sulfate) was added. The results are shown in Table 4.

TABLE 4
Testing of different RCL-MHPCs in base coat render
(23° C./50% relative air humidity)

| Basic material | Basic mixture base coat render | | |
|---|---|---|---|
| Additives (amount | 0.1% MHPC 65000 + | 0.08% MHPC 65000 + | 0.08% RCL-MHPC + |
| on basic-mixture) | 0.01% AEA | 0.01% AEA | 0.01% AEA |
| Water factor | 0.2 | 0.2 | 0.2 |
| Water retention | 97.95 | 97.22 | 97.92 |
| (%, DIN) | | | |
| Flow (mm) | 190 | 195 | 190 |
| Fresh mortar | 1770 | 1791 | 1781 |
| density (g/l) | | | |
| Air content (%) | 17 | 16.5 | 16.5 |

When addition level of the control sample (MHPC 65000) was reduced by 20%, a slight decrease in water retention was observed. The corresponding value decreased by about 0.7%, which was outside of the experimental error (±0.5%). RCL-MHPC was also tested at a 20% reduced dosage level. Nevertheless, water retention as well as the other investigated wet mortar properties of the resulting base coat render were still comparable to the control sample, which was tested at the higher addition level.

In another test series, water retention of base coat render was determined based on CE-addition level. Again, RCL-based MHPC was compared with control MHPC 65000. The outcome of this investigation is shown in FIG. 2:

It is clearly demonstrated that RCL-based MHPC has a superior application performance with respect to water retention capability as compared to currently used high viscosity MHPC as the control. Especially, at a lower CE-dosage level (below 0.08%) a clear advantage of the RCL-based material was observed.

### EXAMPLE 5

All tests were conducted in a render base-coat basic-mixture of 14.0 wt % Portland Cement CEM I 42.5R, 4.0 wt % hydrated lime, 39.0 wt % silica sand with particle sizes of 0.1-0.4 mm, and 43.0 wt % silica sand with particle sizes of 0.5-1.0 mm.

Determination of Water Retention, Flow, Density and Air-Content of Mortar

Water retention, flow, density and air-content of the wet mortar were determined as described in Example 3.

Methylhydroxypropylcellulose (MHPC) made from RCL was blended with polyacrylamide (PAA; aqueous viscosity at 0.5 wt %: 850 mPas; molecular weight: 8-15 million g/mol; density: 825±50 g/dm³; anionic charge: 15-50 wt %) and starch ether (STE; hydroxypropoxyl-content: 10-35 wt %; bulk density: 350-550 g/dm³; moisture content as packed: max 8%; particle size (Alpine air sifter): max. 20% residue on 0.4 mm sieve; solution viscosity of 1500-3000 mPas (at 10 wt %, Brookfield RVT, 20 rpm, 20° C.), respectively and tested in a base coat render (cement-based plaster) basic-mixture in comparison to high viscosity commercial MHPC as the control which was modified accordingly. In order to have a better workability, in all cases an air-entraining agent (AEA) was added. The results are shown in Tables 5 and 6.

TABLE 5
Testing of different modified MHPCs in base coat
render (23° C./50% relative air humidity)

| Basic material | Basic mixture base coat render + 0.01% AEA | | |
|---|---|---|---|
| Additives | 98% MHPC 65000 + | 98% MHPC 65000 + | 98% RCL-MHPC + |
| | 2% PAA | 2% PAA | 2% PAA |
| Dosage (on basic- | 0.1 | 0.08 | 0.08 |
| mixture) (wt %) | | | |
| Water factor | 0.2 | 0.2 | 0.2 |
| water retention | 97.9 | 97.2 | 98.1 |
| (%, DIN) | | | |
| Flow (mm) | 175 | 172 | 176 |
| Fresh mortar | 1718 | 1757 | 1763 |
| density (g/l) | | | |
| Air content (%) | 19.5 | 17.5 | 18 |

Table 5 shows that although modified RCL-MHPC was tested at 20% reduced addition level as compared to the control, the resulting render nevertheless had comparable wet mortar properties with respect to water retention and flow behavior.

TABLE 6
Testing of different modified MHPCs in base coat
render (23° C./50% relative air humidity)

| Basic material | Basic mixture base coat render + 0.01% AEA | | |
|---|---|---|---|
| Additives | 95% MHPC 65000 + | 95% MHPC 65000 + | 95% RCL-MHPC + |
| | 5% STE | 5% STE | 5% STE |
| Dosage (on basic- | 0.1 | 0.08 | 0.08 |
| mixture) (wt %) | | | |
| Water factor | 0.2 | 0.2 | 0.2 |
| water retention | 97.8 | 96.6 | 97.0 |
| (%, DIN) | | | |
| Flow (mm) | 172 | 181 | 172 |
| Fresh mortar density | 1746 | 1786 | 1751 |
| (g/l) | | | |
| Air content (%) | 18.5 | 17 | 19 |

Table 6 illustrates that STE-modified RCL-MHPC is more efficient than commercial MHPC 65000 (control) modified in the same way. When both samples were compared at the same dosage level (0.08 wt % on basic-mixture), better performance of the modified RCL-MHPC with respect to water retention and thickening effect were achieved.

### EXAMPLE 6

All tests were conducted in a render base-coat basic-mixture of 14.0 wt % Portland Cement CEM I 42.5R, 4.0 wt % hydrated lime, 39.0 wt % silica sand with particle sizes 0.1-0.4 mm and 43.0 wt % silica sand with particle sizes 0.5-1.0 mm.

Determination of Water Retention, Flow, Density and Air-Content of Mortar

Water retention, flow, density and air-content of the wet mortar were determined as described in Example 3.

Methylhydroxyethylcellulose (MHEC) made from RCL was blended with polyacrylamide (PAA; molecular weight: 8-15 million g/mol; density: 825±100 g/dm³; anionic charge: 15-50 wt %) and starch ether (STE) (for description of used PAA and STE please see Example 5), respectively and tested in a base coat render (cement-based plaster) basic-mixture in comparison to high viscosity commercial MHEC (control) which was modified similarly. In order to have a better workability in all cases an air-entraining agent (AEA) of sodium C12-C18 alkyl sulfate was added. The results are shown in Tables 7 and 8.

TABLE 7
Testing of different modified MHECs in base coat
render (23° C./50% relative air humidity)

| Basic material | Basic mixture base coat render + 0.01% AEA | | |
|---|---|---|---|
| Additives | 98% MHEC 75000 + | 98% MHEC 75000 + | 98% RCL-MHEC + |
| | 2% PAA | 2% PAA | 2% PAA |
| Dosage (on basic- | 0.1 | 0.08 | 0.08 |
| mixture) (wt %) | | | |
| Water factor | 0.2 | 0.2 | 0.2 |
| Water retention (%, | 97.7 | 95.0 | 98.0 |
| DIN) | | | |
| Flow (mm) | 172 | 176 | 175 |
| Fresh mortar density | 1711 | 1742 | 1736 |
| (g/l) | | | |
| Air content (%) | 19.5 | 18 | 18 |

RCL-MHEC, which was blended with PAA showed similar water retention to the control sample, although the dosage level was 20% lower. Fresh mortar density and air content were slightly different. When modified MHEC 75000 (control) was tested at reduced addition level, the resulting mortar had a 3% lower water retention in comparison to the mortar containing modified RCL-MHEC.

TABLE 8
Testing of different modified MHECs in base coat
render (23° C./50% relative air humidity)

| Basic material | Basic mixture base coat render + 0.01% AEA | | |
|---|---|---|---|
| Additives | 95% MHEC 75000 + | 95% MHEC 75000 + | 95% RCL-MHEC + |
| | 5% STE | 5% STE | 5% STE |
| Dosage (on basic- | 0.1 | 0.08 | 0.08 |
| mixture) (wt %) | | | |
| Water factor | 0.2 | 0.2 | 0.2 |
| Water retention | 96.8 | 95.5 | 95.9 |
| (%, DIN) | | | |
| Flow (mm) | 173 | 177 | 175 |
| Fresh mortar density | 1730 | 1778 | 1741 |
| (g/l) | | | |
| Air content (%) | 18 | 17 | 18 |

It can be seen from Table 8 that when both, modified MHEC 75000 as well as modified RCL-MHEC, were tested at reduced dosage levels, a slightly higher water retention for the RCL-MHEC containing mortar was measured.

### EXAMPLE 7

All tests were conducted in a render base-coat basic-mixture of 14.0 wt % Portland Cement CEM I 42.5R, 4.0 wt % hydrated lime, 39.0 wt % silica sand with particle sizes of 0.1-0.4 mm and 41.0 wt % silica sand with particle sizes of 0.5-1.0 mm.

Determination of Water Retention, Flow, Density and Air-Content of Mortar

Water retention, flow, density and air-content of the wet mortar were determined as described in Example 3.

Hydroxyethylcellulose made from RCL in Hercules pilot plant was tested in a base coat render (cement-based plaster) basic-mixture in comparison to a pilot plant HEC as control, which was made from purified linters under the same process conditions. In all tests an air-entraining agent (AEA; sodium C12-C18 alkyl sulfate) was added. The results are shown in Table 9.

TABLE 9
Testing of different RCL-HECs in base coat render
23° C./50% relative air humidity)

| Basic material | Basic mixture base coat render | | |
|---|---|---|---|
| Additives (amount on | 0.1% purified | 0.08% purified | 0.08% RCL |
| basic-mixture) | linters HEC + | linters HEC + | HEC + |
| | 0.01% AEA | 0.01% AEA | 0.01% AEA |
| Water factor | 0.2 | 0.2 | 0.2 |
| Water retention (%) | 96.67 | 93.17 | 96.79 |
| Flow (mm) | 179 | 182 | 178 |
| Fresh mortar density | 1783 | 1815 | 1765 |
| (g/l) | | | |
| Air content (%) | 16 | 15 | 17 |

Table 9 clearly shows that HEC made from RCL is much more efficient than the control sample, which is based on purified linters. Although the dosage level of RCL-HEC was 20% lower in comparison to the control, all investigated wet mortar properties were about the same, whereas when the addition level of purified linters HEC (control) was reduced by 20%, application performance was significantly reduced; Water retention decreased by 3.5%.

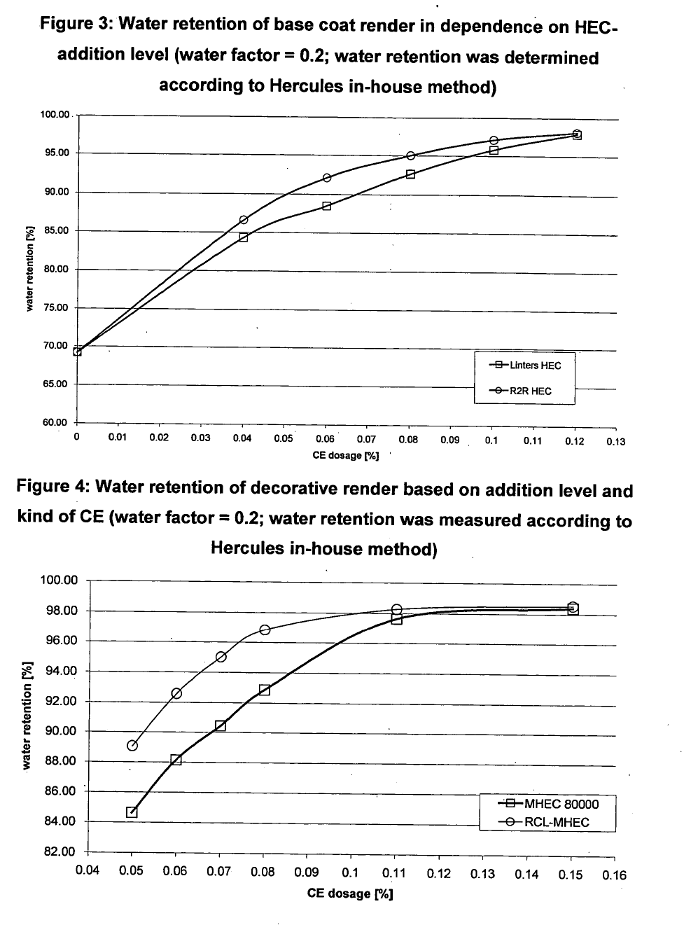

FIG. 3 shows the influence of CE addition levels on water retention for both HEC-types where HEC based on RCL has improved water retention capability as compared to purified linters HEC. At dosage levels lower than 0.12%, water retention was always higher at the same addition level, i.e. while using RCL-HEC similar water retention was reached at a significant lower dosage level.

### EXAMPLE 8

All tests were conducted in a decorative render basic-mixture of 20.0 wt % Portland Cement CEM I 42.5 R white, 2.0 wt % hydrated lime, 30.0 wt % silica sand F 34, 23.0 wt % limestone with particle sizes 0.5-1.0 mm, and 25.0 wt % with particle sizes limestone 0.7-1.2 mm.

Determination of Water Retention, Flow, Density and Air-Content of Mortar

Water retention, flow, density and air-content of the wet mortar were determined as described in Example 3.

Methylhydroxyethylcellulose (MHEC) made from RCL was tested in a decorative render (cement-based plaster) basic-mixture in comparison to commercially available, high viscosity MHECs (from Hercules) which is the control. The results are shown in Table 10 and FIG. 4.

TABLE 10
Testing of different cellulose ethers in decorative render (23° C./50% relative air humidity)

| Basic material | Basic mixture decorative render | | | |
|---|---|---|---|---|
| Additives (amount on | 0.08% MHEC 80000 + | 0.08% MHEC | 0.08% RCL MHEC + | 0.08% RCL MHEC + |
| basic-mixture) | 0.01% AEA | 75000 + 0.01% | 0.01% AEA | 0.01% AEA |
| | (sodium C12-C18 | AEA | | |
| | alkyl sulfate) | | | |
| Water factor | 0.2 | 0.2 | 0.2 | 0.21 |
| Water retention (%, | 96.6 | 97.3 | 97.6 | 97.2 |
| DIN) | | | | |
| Flow (mm) | 160 | 164 | 157 | 160 |
| Fresh mortar density | 1729 | 1764 | 1733 | 1741 |
| (g/l) | | | | |
| Air content (%) | 19 | 17.5-18 | 19 | 18.5 |

As shown in Table 10, RCL-MHEC exhibits a stronger thickening effect as compared to the control samples. This effect was indicated by the lower flow/spreading value of the render containing RCL-MHEC. When the water factor was increased from 0.2 to 0.21, a similar flow was measured. But even at the increased water factor, similar water retention was measured. All other properties were also comparable.

These tests clearly demonstrated that RCL-based MHEC has a superior application performance with respect to water retention capability as compared to currently used high viscosity MHEC as the control sample. Especially, at lower CE-dosage level, a clear advantage of the RCL-based material was observed. Here, at the same addition level, higher water retention was achieved, i.e. the same water retention was reached at a significantly reduced dosage level.

The data in Table 10 and FIG. 4 clearly show that RCL-based MHEC is an efficient cellulose ether which exhibits similar application performance at reduced addition level.

Although the invention has been described with reference to preferred embodiments, it is to be understood that variations and modifications in form and detail thereof may be made without departing from the spirit and scope of the claimed invention. Such variations and modifications are to be considered within the purview and scope of the claims appended hereto.

1. A mixture composition for use in a render composition comprising
a) a cellulose ether in an amount of 20 to 99.9 wt % selected from the group consisting of alkylhydroxyalkyl celluloses, hydroxyalkyl celluloses, and mixtures thereof, prepared from raw cotton linters, and
b) at least one additive in an amount of 0.1 to 80 wt % selected form the group consisting of organic or inorganic thickening agents, anti-sag agents, air entraining agents, wetting agents, defoamers, superplasticizers, dispersants, calcium-complexing agents, retarders, accelerators, water repellants, redispersible powders, biopolymers, and fibres,
wherein when the mixture is used in a dry render formulation and mixed with a sufficient amount of water, the formulation will produce a plaster mortar that can be applied to substrates, wherein the amount of the mixture in the plaster mortar is significantly reduced while water retention and thickening and/or sag-resistance of the wet plaster mortar are comparable or improved as compared to when using conventional similar cellulose ethers.

2. The mixture composition of claim 1 wherein the alkyl group of the alkylhydroxyalkyl cellulose has 1 to 24 carbon atoms, and the hydroxyalkyl group has 2 to 4 carbon atoms.

3. The mixture composition of claim 1 wherein the cellulose ether is selected from the group consisting of methylhydroxyethylcelluloses (MHEC), methylhydroxypropylcelluloses (MHPC), hydroxyethylcellulose (HEC), ethylhydroxyethylcelluloses (EHEC), methylethylhydroxyethylcelluloses (MEHEC), hydrophobically modified ethylhydroxyethylcelluloses (HMEHEC), hydrophobically modified hydroxyethylcelluloses (HMHEC) and mixtures thereof.

4. The mixture composition of claim 1, wherein the mixture also comprises one or more conventional cellulose ethers selected from the group consisting of methylcellulose (MC), methylhydroxyethylcellulose (MHEC), methylhydroxypropylcellulose (MHPC), hydroxyethylcellulose (HEC), ethylhydroxyethylcellulose (EHEC), hydrophobically modified hydroxyethylcellulose (HMHEC), hydrophobically modified ethylhydroxyethylcellulose (HMEHEC), methylethylhydroxyethylcellulose (MEHEC), sulfoethyl methylhydroxyethylcelluloses (SEMHEC), sulfoethyl methylhydroxypropylcelluloses (SEMHPC), and sulfoethyl hydroxyethylcelluloses (SEHEC).

5. The mixture composition of claim 1, wherein the amount of the cellulose ether is 70 to 99 wt %.

6. The mixture composition of claim 1, wherein the amount of the additive is 0.5 to 30 wt %.

7. The mixture composition of claim 1, wherein the at least one additive is an organic thickening agent selected from the group consisting of polysaccharides.

8. The mixture composition of claim 7, wherein the polysaccharides are selected from the group consisting of starch ether, starch, guar, guar derivatives, dextran, chitin, chitosan, xylan, xanthan gum, welan gum, gellan gum, mannan, galactan, glucan, arabinoxylan, alginate, and cellulose fibres.

9. The mixture composition of claim 1, wherein the at least one additive is selected from the group consisting of homo- or co-polymers of acrylamide, gelatin, polyethylene glycol, casein, lignin sulfonates, naphthalene-sulfonate, sulfonated melamine-formaldehyde condensate, sulfonated naphthalene-formaldehyde condensate, polyacrylates, polycarboxylate ether, polystyrene sulphonates, phosphates, phosphonates, calcium-salts of organic acids having 1 to 4 carbon atoms, salts of alkanoates, aluminum sulfate, metallic aluminum, bentonite, montmorillonite, sepiolite, polyamide fibres, polypropylene fibres, polyvinyl alcohol, and homo-, co-, or terpolymers based on vinyl acetate, maleic ester, ethylene, styrene, butadiene, vinyl versatate, and acrylic monomers.

10. The mixture composition of claim 1, wherein the at least one additive is selected from the group consisting of calcium chelating agents, fruit acids, and surface active agents.

11. The mixture composition of claim 1, wherein the significantly reduced amount of the mixture used in the plaster mortar is at least 5% reduction.

12. The mixture composition of claim 1, wherein the significantly reduced amount of the mixture used in the plaster mortar is at least 10% reduction.

13. The mixture composition of claim 7, wherein the mixture composition is MHEC and an additive selected from the group consisting of homo- or co-polymers of acrylamide, starch ether, and mixtures thereof.

14. The mixture composition of claim 13, wherein the co-polymers of acrylamide is selected from the group consisting of poly(acrylamide-co-sodium acrylate), poly(acrylamide-co-acrylic acid), poly(acrylamide-co-sodium acrylamido methylpropanesulfonate), poly(acrylamide-co-acrylamido methylpropanesulfonic acid), poly(acrylamide-co-diallyidimethylammonium chloride), poly(acrylamide-co-(acryloylamino)propyltrimethylammoniumchloride), poly(acrylamide-co-(acryloyl)ethyltrimethylammoniumchloride), and mixtures thereof.

15. The mixture composition of claim 13, wherein the starch ether is selected from the group consisting of hydroxyalkylstarches where the alkyl has 1 to 4 carbon atoms, carboxymethylated starch ethers, and mixtures thereof.

16. The mixture composition of claim 7, wherein the mixture is MHPC and an additive selected from the group consisting of homo- or co-polymers of acrylamide, starch ether, and mixtures thereof.

17. The mixture composition of claim 16, wherein the co-polymers of acrylamide are selected from the group consisting of poly(acrylamide-co-sodium-acrylate), poly(acrylamide-co-acrylic acid), poly(acrylamide-co-sodium-acrylamido methylpropanesulfonate), poly(acrylamide-co-acrylamido methylpropanesulfonic acid), poly(acrylamide-co-diallyldimethylammonium chloride), poly(acrylamide-co-(acryloylamino)propyltrimethylammoniumchloride), poly(acrylamide-co-(acryloyl)ethyltrimethylammoniumchloride), and mixtures thereof.

18. The mixture composition of claim 17, wherein the starch ether is selected from the group consisting of hydroxyalkylstarches where the alkyl has 1 to 4 carbon atoms, carboxymethylated starch ethers, and mixtures thereof.

19. A dry render composition comprising at least hydraulic cement, fine aggregate material, and a water-retaining agent of at least one cellulose ether prepared from raw cotton linters,
wherein the dry render composition, when mixed with a sufficient amount of water, produces a plaster mortar which can be applied on substrates, wherein the amount of water retaining agent in the plaster mortar is significantly reduced while the water retention and thickening and/or sag-resistance of the wet plaster mortar are comparable or improved as compared to when using conventional similar cellulose ethers.

20. The dry render composition of claim 19, wherein the at least one cellulose ether is selected from the group consisting of alkylhydroxyalkyl celluloses and hydroxyalkyl celluloses and mixtures thereof, prepared from raw cotton linters.

21. The dry render composition of claim 20, wherein the alkyl group of the alkylhydroxyalkyl celluloses has 1 to 24 carbon atoms and the hydroxyalkyl group has 2 to 4 carbon atoms.

22. The dry render composition of claim 19, wherein the at least one cellulose ether is selected from the group consisting of methylhydroxyethylcelluloses (MHEC), methylhydroxypropylcelluloses (MHPC), hydroxyethylcelluloses (HEC), methylethylhydroxyethylcelluloses (MEHEC), ethylhydroxyethylcelluloses (EHEC), hydrophobically modified ethylhydroxyethylcelluloses (HMEHEC), hydrophobically modified hydroxyethylcelluloses (HMHEC) and mixtures thereof.

23. The dry render composition of claim 22, wherein the cellulose ether, where applicable, has a methyl or ethyl degree of substitution of 0.5 to 2.5, hydroxyethyl or hydroxypropyl molar substitution (MS) of 0.01 to 6, and molar substitution (MS) of the hydrophobic substituents of 0.01-0.5 per anhydroglucose unit.

24. The dry render composition of claim 19, wherein the dry render composition also comprises one or more conventional cellulose ethers selected from the group consisting of methylcellulose (MC), methylhydroxyethylcellulose (MHEC), methylhydroxypropylcellulose (MHPC), hydroxyethylcellulose (HEC), ethylhydroxyethylcellulose (EHEC), hydrophobically modified hydroxyethylcellulose (HMHEC), hydrophobically modified ethylhydroxyethylcellulose (HMEHEC), methylethylhydroxyethylcellulose (MEHEC), sulfoethyl methylhydroxyethylcelluloses (SEMHEC), sulfoethyl methylhydroxypropylcelluloses (SEMHPC), and sulfoethyl hydroxyethylcelluloses (SEHEC.

25. The dry render composition of claim 19, wherein the amount of cellulose ether is between 0.01 and 2.0 wt %.

26. The dry render composition of claim 19 in combination with one or more additives selected from the group consisting of organic or inorganic thickening agents, anti-sag agents, air entraining agents, wetting agents, defoamers, superplasticizers, dispersants, calcium-complexing agents, retarders, accelerators, water repellants, redispersible powders, biopolymers, and fibres.

27. The dry render composition of claim 26, wherein the one or more additives are organic thickening agents selected from the group consisting of polysaccharides.

28. The dry render composition of claim 27, wherein the polysaccharides are selected from the group consisting of starch ether, starch, guar, guar derivatives, dextran, chitin, chitosan, xylan, xanthan gum, welan gum, gellan gum, mannan, galactan, glucan, arabinoxylan, alginate, and cellulose fibres.

29. The dry render composition of claim 26, wherein the one or more additives are selected from the group consisting of homo- or co-polymers of acrylamide, starch ether, gelatin, polyethylene glycol, casein, lignin sulfonates, naphthalene-sulfonate, sulfonated melamine-formaldehyde condensate, sulfonated naphthalene-formaldehyde condensate, polyacrylates, polycarboxylateether, polystyrene sulphonates, fruit acids, phosphates, phosphonates, calcium-salts of organic acids having 1 to 4 carbon atoms, salts of alkanoates, aluminum sulfate, metallic aluminum, bentonite, montmorillonite, sepiolite, polyamide fibres, polypropylene fibres, polyvinyl alcohol, and homo-, co-, or terpolymers based on vinyl acetate, maleic ester, ethylene, styrene, butadiene, vinyl versatate, and acrylic monomers.

30. The dry render composition of claim 26, wherein the amount of the one or more additives is between 0.0001 and 10 wt %.

31. The dry render composition of claim 19, wherein the fine aggregate material is selected from the group consisting of silica sand, dolomite, limestone, lightweight aggregates, rubber crumbs, and fly ash.

32. The dry render composition of claim 31, wherein the lightweight aggregates are selected from the group consisting of perlite, expanded polystyrene, hollow glass spheres, cork, and expanded vermiculite.

33. The dry render composition of claim 19, wherein the fine aggregate material is present in the amount of 40-90 wt %.

34. The dry render composition of claim 19, wherein the fine aggregate material is present in the amount of 60-85 wt %.

35. The dry render composition of claim 19, wherein the hydraulic cement is selected from the group consisting of Portland cement, Portland-slag cement, Portland-silica fume cement, Portland-pozzolana cement, Portland-burnt shale cement, Portland-limestone cement, Portland-composite cement, blast furnace cement, pozzolana cement, composite cement and calcium aluminate cement.

36. The dry render composition of claim 19, wherein the hydraulic cement is present in the amount of 5-60 wt %.

37. The dry render composition of claim 19, wherein the hydraulic cement is present in the amount of 10-50 wt %.

38. The dry render composition of claim 19 in combination with at least one mineral binder selected from the group consisting of hydrated lime, gypsum, puzzolana, blast furnace slag, and hydraulic lime.

39. The dry render composition of claim 38, wherein the at least one mineral binder is present in the amount of 0.1-30 wt %.

40. The dry render composition of claim 22, wherein the MHEC or MHPC has an aqueous Brookfield solution viscosity of greater than 80,000 mPas as measured on a Brookfield RVT viscometer at 2 wt %, 20° C., and 20 rpm, using spindle number 7.

41. The dry render composition of claim 22, wherein the MHEC or MHPC has an aqueous Brookfield solution viscosity of greater than 90,000 mPas as measured on a Brookfield RVT viscometer at 2 wt %, 20° C. and 20 rpm, using spindle number 7.

42. The dry render composition of claim 19, wherein the significantly reduced amount of the cellulose ether used in the dry render composition is at least 5% reduction.

43. The dry render composition of claim 19, wherein the significantly reduced amount of the cellulose ether used in the dry render composition is at least 10% reduction.
